(19) United States
(12) Patent Application Publication
(10) Pub. No.: US 2007/0079584 A1
(43) Pub. Date: Apr. 12, 2007

(54) Multi-cyclone dust collector for vacuum cleaner and dust collecting method

(75) Inventors: Tak-soo Kim, Gwangju-city (KR); Yong-hee Lee, Gwangju-city (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/411,270

(22) Filed: Apr. 26, 2006

(30) Foreign Application Priority Data
Oct. 11, 2005 (KR) 10-2005-0095417
Oct. 28, 2005 (KR) 10-2005-0102616

(51) Int. Cl. B01D 45/12

(52) U.S. Cl. 55/345

(57) ABSTRACT

The present invention relates to a multi-cyclone dust collector for a vacuum cleaner and dust collecting chamber. The multi-cyclone dust collector includes a first cyclone unit having a first cyclone body and a first dust collecting chamber, the first cyclone body taking dust-laden air entering through an under portion thereof and forming a first upwardly whirling air current so as to separate contaminants centrifugally from the dust-laden air, the first dust collecting chamber collecting contaminants discharged from the first cyclone body; and a second cyclone unit wrapping around at least a portion of the first dust collecting chamber, sucking semi-clean air discharged from the first cyclone unit through an under portion thereof, taking the sucked semi-clean air and forming a second upwardly whirling air current so as to separate contaminants centrifugally from the semi-clean air.

### CROSS-REFERENCE TO RELATED APPLICATIONS

This application claims the benefit under 35 U.S.C. § 119(a) from Korean Patent Applications No. 2005-095417 filed on Oct. 11, 2005 and No. 2005-102616 filed on Oct. 28, 2005 in the Korean Intellectual Property Office, the disclosures of both of the above cited applications are incorporated herein by reference in their entirety.

### BACKGROUND OF THE INVENTION

1. Field of the Invention

The present invention relates to a vacuum cleaner. More particularly, the present invention relates to a multi-cyclone dust collector for a vacuum cleaner and a dust collecting method.

2. Description of the Related Art

Generally, a vacuum cleaner sucks contaminants such as dust and dirt on a cleaning surface with air into a cleaner body by suction force generated by a vacuum generator. Sucked dust-laden air passes through a dust collector disposed in the cleaner body of the vacuum cleaner. Then, contaminants are separated from the sucked air and collected by the dust collector. Clean air having contaminants removed is discharged out of the cleaner body of the vacuum cleaner.

The dust collector that separates and collects contaminants from dust-laden air may employ a dust bag, a cyclone dust collector, and so on. Nowadays, cyclone dust collectors separating contaminants by centrifugal force and providing semi permanent use have become widespread.

Some examples of conventional cyclone dust collectors are disclosed in Korean patent applications No. 10-2000-56658 (filed Feb. 24, 1999) and No. 10-2000-56659 (filed Feb. 24, 1999). The conventional cyclone dust collectors include a cyclone body, which forms the sucked dust-laden air into a whirling current, and takes on a cylindrical shape, an air inlet for dust-laden air to be entered, and an air outlet for clean air to be discharged. The air inlet is disposed at a side of an upper portion of the cyclone body in a substantially tangential direction to the cyclone body so that the entered air can easily whirl down. The air outlet is disposed at a center of a top surface of the cyclone body so that air, which has contaminants removed whirling down and then rises up inside the cyclone body, can be discharged out of the cyclone dust collector.

However, in the conventional cyclone dust collector, the whirling down entering air collides with the discharging air rising up inside the cyclone body because both the air inlet and the air outlet are disposed at the upper portion of the cyclone body. Therefore, the dust collecting efficiency of the conventional cyclone dust collector is decreased due to the collision between the entering air and the discharging air.

Furthermore, the conventional cyclone dust collector has a cyclone so that it may not filter fine contaminants completely. Therefore, a multi-cyclone dust collector has been developed that separates and collects contaminants from the sucked air in two stages to allow fine contaminants be filtered. An example of the multi-cyclone dust collector is disclosed in Korean patent application No. 10-2005-25711 (filed Sep. 8, 2003). However, the multi-cyclone dust collector still has the drawback of decreased dust collecting efficiency due to air collision.

Furthermore, in the conventional cyclone dust collector structure, a dust receptacle shares a space under the cyclone body with the cyclone body so that contaminants collected in the dust receptacle may flow back to the air outlet with air that whirls down and then raises up. Therefore, the dust collecting efficiency of the conventional cyclone dust collector is decreased.

Furthermore, in the conventional cyclone dust collector structure, the dust receptacle is disposed in a line under the cyclone body so that the cyclone dust collector is tall. Therefore, it is hard to provide a compact vacuum cleaner.

### SUMMARY OF THE INVENTION

The present invention has been developed in order to overcome the above-mentioned drawbacks and other problems associated with the conventional arrangement. An aspect of the present invention is to provide a multi-cyclone dust collector for a vacuum cleaner that can separate fine contaminants and has high dust collecting efficiency because the entering air and discharging air do not collide with each other.

Another aspect of the present invention is to provide a multi-cyclone dust collector for a vacuum cleaner having a compact structure, especially having a short height.

Still another aspect of the present invention is to provide a multi-cyclone dust collector for a vacuum cleaner that it is convenient to empty collected contaminants because collected contaminants can be discharged through a top side of the cyclone dust collector.

The above aspects and/or other feature of the present invention can substantially be achieved by providing a multi-cyclone dust collector for a vacuum cleaner, which includes a first cyclone unit comprising a first cyclone body and a first dust collecting chamber, the first cyclone body taking dust-laden air entered through an under portion thereof and forming an upwardly whirling air current so as to separate centrifugally contaminants from the dust-laden air, the first dust collecting chamber collecting contaminants discharged from the first cyclone body; and a second cyclone unit wrapping around at least some part of the first dust collecting chamber, sucking semi-clean air discharged from the first cyclone unit through an under portion thereof, taking the sucked semi-clean air and forming another upwardly whirling air current so as to separate centrifugally contaminants from the semi-clean air.

According to an embodiment of the present invention, the first cyclone unit comprises: a first cyclone body formed in a substantially hollow cylindrical shape, inside which the sucked dust-laden air whirls; an air communicating member disposed inside the first cyclone body, discharging the semi-clean air to the second cyclone unit; a dust collecting wall wrapping around the first cyclone body, collecting contaminants discharged from the first cyclone body; and an air suction pipe disposed at a bottom of the first cyclone body, forming the sucked dust-laden air into a first upwardly whirling air current.

According to an embodiment of the present invention, the air communicating member is formed in a substantially cylindrical shape, and has an open top end and an bottom end formed as a plurality of air passages corresponding to the second cyclone unit.

According to an embodiment of the present invention, an air guide member is formed at a center of a bottom end of the air communicating member.

According to an embodiment of the present invention, the second cyclone unit comprises: a plurality of second cyclones wrapping around the dust collecting wall, under portions of the plurality of second cyclones in fluid communication with the bottom end of the air communicating member, the plurality of second cyclones forming semi-clean air entered through the air communicating member into a second upwardly whirling air current so as to separate contaminants; and a second dust collecting chamber wrapping around the plurality of second cyclones, collecting contaminants discharged from the plurality of second cyclones.

According to an embodiment of the present invention, each of the plurality of second cyclones comprises: a second cyclone body formed in a substantially hollow conical shape with a closed bottom end, having a second air suction port an under portion thereof in fluid communication with the bottom end of the air communicating member; and an air-discharging pipe formed in a substantially hollow cylindrical shape, projected upwardly from a center of the bottom of the second cyclone body, and discharging air cleaned in the second cyclone body.

According to an embodiment of the present invention, an upper cover covers detachably upper ends of the fist and second cyclone units. The upper cover comprises a backflow preventing dam to prevent contaminants collected in the first dust collecting chamber from flowing back to the first cyclone body. The upper cover further comprises a substantially dome-shaped contaminants guide member on a center of a bottom surface thereof.

According to an embodiment of the present invention, each of the plurality of second cyclone bodies comprises a cyclone body, and a top end of the cyclone body is inclined in an opposite direction of the first cyclone unit with respect to a bottom end of the cyclone body.

At this time, at least one of the plurality of second cyclones inserts some circumferential surface thereof into the first dust collecting chamber.

According to an embodiment of the present invention, the second dust collecting chamber is formed as a space between a dust receptacle and a dust collecting wall, the dust receptacle so formed in a substantially hollow cylindrical shape so as to wrap around the outside of the plurality of second cyclones and the first cyclone body, the dust collecting wall having opposite ends thereof connected with the dust receptacle; and the first dust collecting chamber is formed as a space between the first cyclone body, the dust collecting wall, with some part of the dust receptacle not wrapped around the plurality of second cyclones; wherein contaminants collected in the first and second dust collecting chambers can be seen outside the dust receptacle.

According to another aspect of the present invention, a multi-cyclone dust collector for a vacuum cleaner comprises; a first cyclone unit having at least one first cyclone that separates contaminants from outside air; and a second cyclone unit separating contaminants from air discharged from the first cyclone unit, having a plurality of second cyclones that separates from the first cyclone and wraps around at least some part of the first cyclone; wherein there are bottoms of the first and second cyclone units on the same horizontal surface.

At this time, the plurality of second cyclones suck air through an under portion of a side thereof, and then discharge air to an under portion of a center thereof. Contaminants collected in the first cyclone unit can be seen through some part not to be wrapped around by the plurality of second cyclones.

According to still another aspect of the present invention, a dust collecting method comprises the steps of: (a) entering outside air into an under portion of at least one first cyclone; (b) whirling the entered air upwardly and separating contaminants contained in the entered air out of the at least one first cyclone; (c) discharging the air to the under portion of the at least one first cyclone through an air communicating member projected from the under portion thereof inside the first cyclone; (d) entering the discharged air into a plurality of second cyclones through second air suction ports formed on under portions of sides of the plurality of second cyclones, whirling the discharged air upwardly, and separating fine contaminants; and (e) discharging air entered inside the plurality of second cyclones to bottoms of the plurality of second cyclones.

At this time, the (b) step comprises discharging the contaminants through an opened top end of the first cyclone and collecting the contaminants in a first dust collecting chamber formed around the first cyclone.

Furthermore, the (d) step comprises discharging the fine contaminants over top ends of the plurality of second cyclones, and collecting the fine contaminants in a space between the plurality of second cyclones.

With the multi-cyclone dust collector for the vacuum cleaner according to an embodiment of the present invention, entering air and discharging air do not collide with each other in the first and second cyclone units so that dust collecting efficiency increases.

Furthermore, with the multi-cyclone dust collector according to an embodiment of the present invention, as sucked dust-laden air passes through the first cyclone unit, relatively large contaminants are separated, and then, as the air passes through the second cyclone unit, remained contaminants are separated. So the multi-cyclone dust collector can separate fine contaminants from dust-laden air.

Furthermore, with the multi-cyclone dust collector according to an embodiment of the present invention, the first and second cyclone units employ a structure that a space where upwardly whirling air current is formed is isolated from a space where contaminants are collected so that dust collecting efficiency increases.

Then, with the multi-cyclone dust collector according to an embodiment of the present invention, a first cyclone body, a dust collecting wall, a plurality of second cyclone bodies, a dust receptacle, and a cyclone bottom member may be formed as one body by an injection molding process for ease of manufacture and/or assembly.

Furthermore, with the multi-cyclone dust collector according to an embodiment of the present invention, the second cyclone unit is disposed around the first cyclone unit and bottom ends of the first and second cyclone units are on the same plane so that a compact multi-cyclone dust collector can be provided. Especially, they can provide a multi-cyclone dust collector with a reduced height.

Furthermore, the multi-cyclone dust collector according to an embodiment of the present invention employs a backflow preventing dam so as to prevent contaminants collected in the first dust collecting chamber from flowing back to the first cyclone body as the multi-cyclone dust collector is inclined.

Furthermore, with the multi-cyclone dust collector according to an embodiment of the present invention, it is convenient for a user to see the quantity of contaminants collected in the first and second dust collecting chambers without opening the upper cover. Also, it is convenient for a user to empty contaminants collected in the first and second dust collecting chambers because the user can dump away contaminants by opening the upper cover and turning the collecting chambers upside-down.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a multi-cyclone dust collector for a vacuum cleaner according to an embodiment of the present invention,

FIG. 2 is an exploded perspective view illustrating the multi-cyclone dust collector of FIG. 1,

FIG. 3 is a perspective view illustrating an under cover of the multi-cyclone dust collector of FIG. 2,

FIG. 4 is a sectional view illustrating the multi-cyclone dust collector of FIG. 1 taken along the line IV-IV in FIG. 1,

FIG. 5 is a sectional view illustrating the multi-cyclone dust collector of FIG. 4 taken along the line V-V in FIG. 4,

FIG. 6 is an upper perspective view illustrating the multi-cyclone dust collector of FIG. 1 without an upper cover,

FIG. 7 is a sectional view illustrating a multi-cyclone dust collector for a vacuum cleaner according to another embodiment of the present invention, and

FIG. 8 is a view illustrating a vacuum cleaner employing a multi-cyclone dust collector according to an embodiment of the present invention.

Throughout the drawings, like reference numerals will be understood to refer to like parts, components and structures.

### DETAILED DESCRIPTION OF THE INVENTION

Hereinafter, certain exemplary embodiments of the present invention will be described in detail with reference to the accompanying drawings.

The matters defined in the description, such as the detailed construction and elements thereof, are provided to assist in a comprehensive understanding of the invention. Thus, it is apparent that the present invention may be carried out without those defined matters. Also, well-known functions or constructions are omitted to provide a clear and concise description of exemplary embodiments of the present invention.

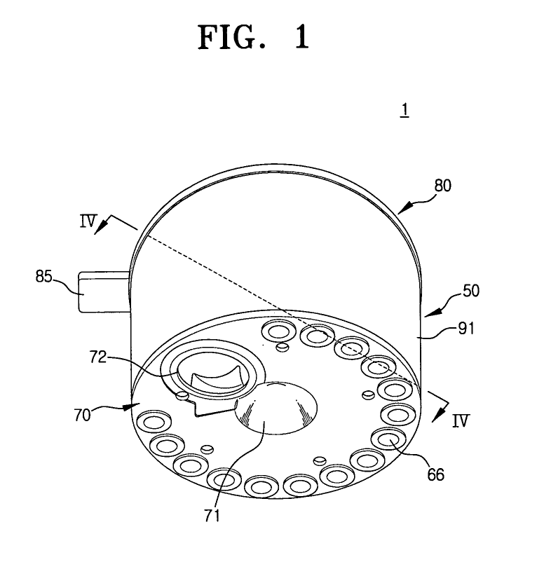

Referring to FIGS. 1 to 4, a multi-cyclone dust collector 1 for a vacuum cleaner according to an embodiment of the present invention includes a first cyclone unit 10 and a second cyclone unit 50.

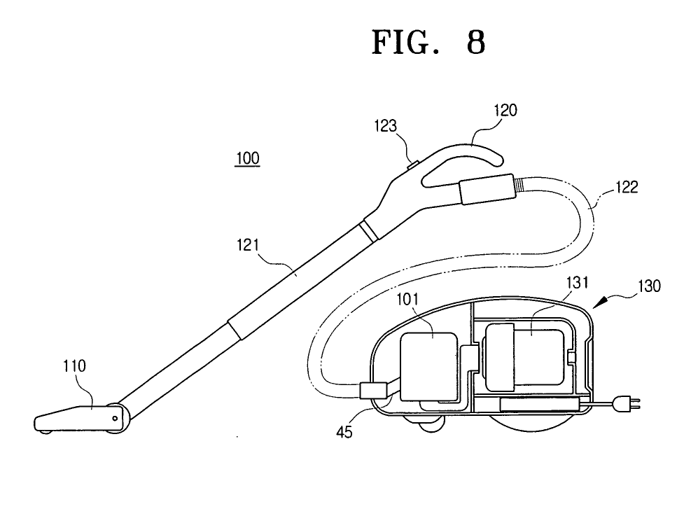

In the present embodiment, the first cyclone unit 10 employs a cyclone, and takes air, which contains contaminants such as dust and dirt and is sucked from a suction brush 110 (see FIG. 8) (hereinafter referred to as dust-laden air), enter through an under portion thereof, and then whirl upwardly so that contaminants are separated from the whirling dust-laden air by centrifugal force. In other words, the first cyclone unit 10 forms the dust-laden air that enters through the under portion thereof into an upwardly whirling air current, and therefore, separates centrifugally contaminants from the dust-laden air.

The first cyclone unit 10 includes a first cyclone body 20, an air communicating member 40, a first dust collecting chamber 30, and an air suction pipe 45.

The first cyclone body 20 is formed in a substantially hollow cylindrical shape with an opened top end and a closed bottom end. Dust-laden air entering through the air suction pipe 45 whirls inside the first cyclone body 20 so as to form a first upwardly whirling air current. A cyclone bottom member 22 closes a bottom end of the first cyclone body 20. A plurality of air passages 43 is formed on an under surface of the cyclone bottom member 22. The plurality of air passages 43 guides air discharging from the first cyclone body 20 to a plurality of second cyclones 60.

An upper cover 80 covers above the first cyclone body 20. A space between the top end of the first cyclone body 20 and the upper cover 80 forms a dust exit 24 through which contaminants separated from dust-laden air by centrifugal force are discharged to the first dust collecting chamber 30. Preferably, the upper cover 80 is formed to be capable of connecting and disconnecting to a dust receptacle 91. In other words, the upper cover 80 is detachably connected to the dust receptacle 91.

The upper cover 80 has a backflow preventing dam 81, a first sealing part 83, and a second sealing part 82 on an under surface thereof. The backflow preventing dam 81 prevents contaminants collected in the first dust collecting chamber 30 from flowing back inside the first cyclone body 20 through the dust exit 24 as the multi-cyclone dust collector 1 is inclined. Preferably, the backflow preventing dam 81 is formed in a substantially cylindrical shape having a diameter greater than that of the first cyclone body 20. The first sealing part 83 is formed a shape corresponding to a section of a dust collecting wall 31, and is inserted in a top end of the dust collecting wall 31 so as to prevent the first dust collecting chamber 30 from being in fluid communication with a second dust collecting chamber 90. The second sealing part 82 is formed a shape corresponding to a section of the dust receptacle 91, and is inserted in a top end of the dust receptacle 91 so as to prevent the second dust collecting chamber 90 from being in fluid communication with the outside. Also, a contaminants guide member 84 is substantially dome-shaped and is disposed on a center of the under surface of the upper cover 80, namely, inside the backflow preventing dam 81. The contaminants guide member 84 helps contaminants separated from the dust-laden air to be discharged to the first dust collecting chamber 30 through the dust exit 24, and clean air having contaminants separated to be discharged to the air communicating member 40. Furthermore, preferably the upper cover 80 has a handle 85 at a side thereof so that it is easy for a user to open or close the upper cover 80.

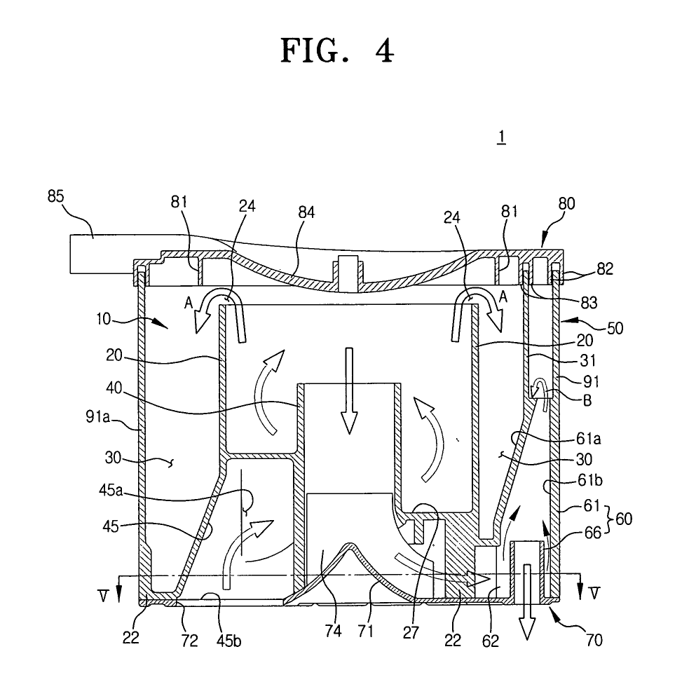

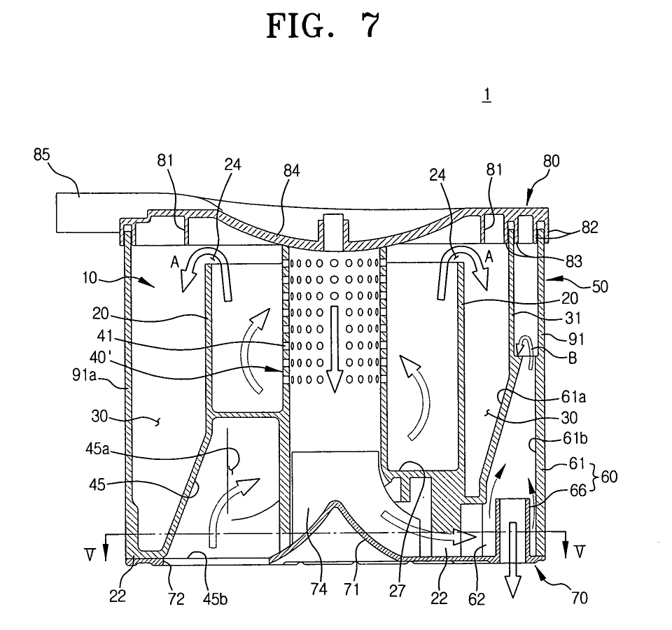

The air communicating member 40 discharges air having contaminants removed from dust-laden air in the first cyclone body 20 by centrifugal force (hereinafter referred to as semi-clean air) to the second cyclone unit 50. The air communicating member 40 is formed in a substantially hollow cylindrical shape, and projected from a center of the cyclone bottom member 22 to the inside of the first cyclone body 20. At this time, a top end of the air communicating member 40 is separated from the contaminants guide member 84 of the upper cover 80. Opposite ends of the air communicating member 40 are opened. The bottom end of the air communicating member 40 is in fluid communication with the plurality of air passages 43 formed on the under surface of the cyclone bottom member 22. Therefore, semi-clean air entering the top end of the air communicating member 40 flows into the plurality of second cyclones 60 through the plurality of air passages 43. In the multi-cyclone dust collector 1 according to an embodiment of the present invention as shown in FIG. 4, the top end of the air communicating member 40 is not in contact with the under surface of the upper cover 80, namely, the contaminants guide member 84. However, in a multi-cyclone dust collector 1 according to another embodiment as shown in FIG. 7, a top end of the air communicating member 40′ may be extended to reach the contaminants guide member 84 of the upper cover 80. The air communicating member 40′ has a plurality of air holes 41 on a surface thereof to discharge semi-clean air. The plurality of air holes 41 comprises many small holes so as to filter relatively large contaminants flowing with the semi-clean air.

The first dust collecting chamber 30 wraps around at least some part of the first cyclone body 20, and collects contaminants discharged from the first cyclone body 20 by centrifugal force. The first dust collecting chamber 30 is formed as a space between the first cyclone body 20, the dust collecting wall 31 in a substantially cylindrical shape wrapping around the first cyclone body 20, and apart 91a of the dust receptacle 91 that does not wrap around the plurality of second cyclones 60. A top end of the first dust collecting chamber 30 is closed by the upper cover 80 covering the top end of the first cyclone body 20, and a bottom end of the first dust collecting chamber 30 is closed by the cyclone bottom member 22.

The air suction pipe 45 is in fluid communication with the suction brush 110, and is formed in the under portion of the first cyclone body 20 so as to allow dust-laden air sucked into the first cyclone body 20 to form the first upwardly whirling air current. In other words, the air suction pipe 45 is inclined upwardly with respect to the bottom of the first cyclone body 20 through the cyclone bottom member 22. Therefore, dust-laden air entered from the suction brush 110 forms the first upwardly whirling air current inside the first cyclone body 20. Furthermore, a slope part 27 is formed so as to be inclined upwardly in a dust-laden air flowing direction on an upper surface of the cyclone bottom member 22 with which the air suction pipe 45 is connected. Dust-laden air entering the first cyclone body 20 through the air suction pipe 45 can easily form the first upwardly whirling air current due to the slope part 27. The slope part 27 is formed in a spiral shape from a bottom end of an exit 45a of the air suction pipe 45 to an upper side of the exit 45a of the air suction pipe 45 around the air communicating member 40.

The second cyclone unit 50 is separated from the first cyclone body 20 and wraps around at least some part of the first cyclone body 20. The second cyclone unit 50 takes the semi-clean air discharged from the first cyclone unit 10 described above, forces the semi-clean air to enter an under portion thereof, and forms a second upwardly whirling air current so that the second cyclone unit separates fine contaminants from the semi-clean air by centrifugal force of the whirling semi-clean air, and then discharges clean air to the vacuum generator 131 (see FIG. 8). The semi-clean air contains fine contaminants that are not removed in the first cyclone unit 10, and the second cyclone unit 50 removes the fine contaminants remaining in the semi-clean air using centrifugal force.

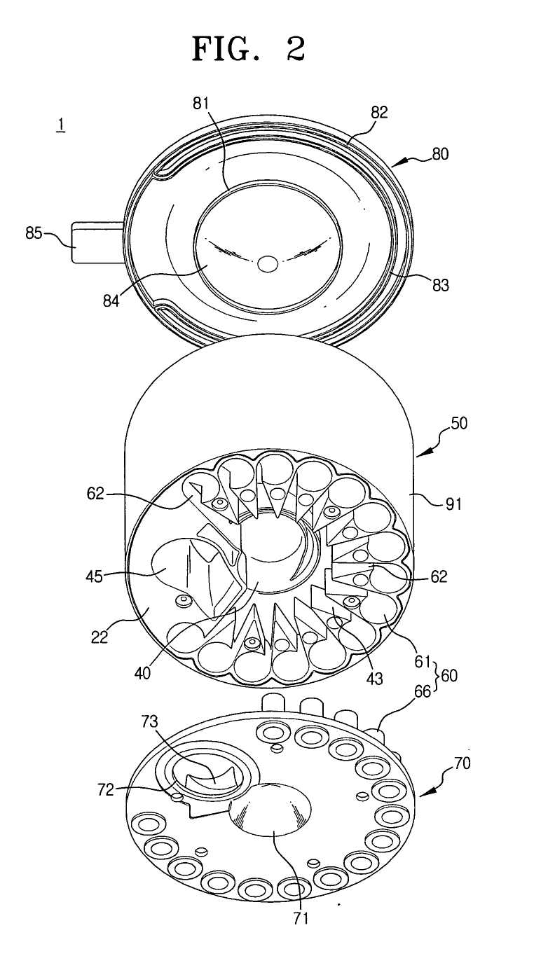

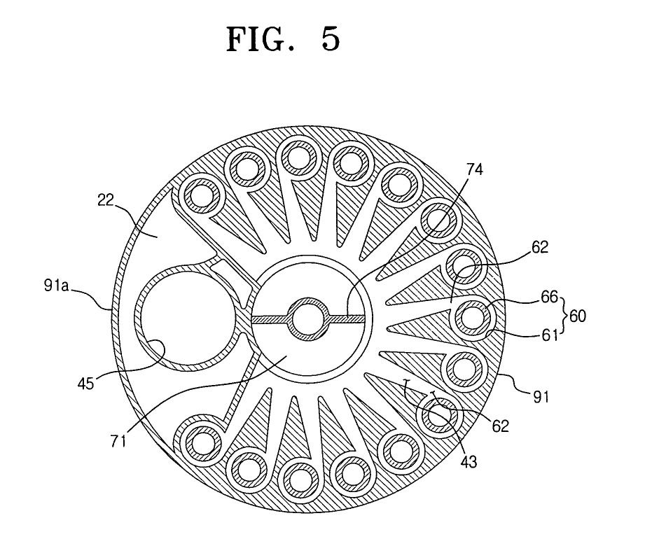

Referring to FIGS. 2 to 6, the second cyclone unit 50 includes a plurality of second cyclones 60 and a second dust collecting chamber 90.

The plurality of second cyclones 60 is wraps around at least some part of the first cyclone unit 10. Second cyclones 60 suck semi-clean air discharged from the first cyclone unit 10 through the under portion thereof, and then form the sucked semi-clean air into the second upwardly whirling air current. Contaminants remaining in the semi-clean air are separated by centrifugal force applied to the second upwardly whirling air current. Clean air is discharged from the plurality of second cyclones 60 to the vacuum generator 131. The plurality of second cyclones 60 wraps around the dust collecting wall 31 forming the first dust collecting chamber 30 as shown in FIGS. 4 to 6. In this embodiment, 15 second cyclones 60 are arranged in a shape similar to a letter C based on a center point of the air communicating member 40. The plurality of second cyclones 60 does not completely wrap around the first cyclone unit 10 so that a user can see the quantity of contaminants collected in the first dust collecting chamber 30 through a part of the first cyclone unit 10 not to be surrounded by the plurality of second cyclones 60. Therefore, it is convenient that the user is not required to open the upper cover 80 to see the quantity of contaminants collected in the first dust collecting chamber 30. For this end, preferably, the dust receptacle 91 is made of a transparent material. Accordingly, it is easy for a user to determine the quantity of contaminants collected in each of the first and second dust collecting chambers 30 and 90 without opening the upper cover 80.

Each of the plurality of second cyclones 60 includes a second cyclone body 61 and an air-discharging pipe 66. The second cyclone body 61 is formed in a substantially hollow conical shape with open opposite ends. Some part 61b of the second cyclone body 61 is formed parallel to the dust collecting wall 31. The dust receptacle 91 wraps around all of the plurality of second cyclone bodies 61. In this embodiment, some part of the dust receptacle 91 forms some part 61b of the second cyclone body 61. Furthermore, some part 61a of each of the plurality of second cyclone bodies 61 is projected inside the dust collecting wall 31. At this time, the some part 61a projected inside the dust collecting wall 31 is inclined with respect to the dust collecting wall 31. In other words, a top end of the second cyclone body 61 is inclined with respect to a bottom end thereof in the opposite direction of the first cyclone unit 10. The plurality of second cyclone bodies 61 is disposed so that the bottom end of each of the plurality of second cyclone bodies 61 contacts with the bottom end of next cyclone body 61. The plurality of second cyclone bodies 61 is lower than a top end of the dust receptacle 91. The bottom ends of the plurality of second cyclone bodies 61 are in fluid communication with the plurality of air passages 43 in the cyclone bottom member 22. A second air suction port 62 is formed where each of the plurality of second cyclone bodies 61 and air passages 43 meets each other. Therefore, semi-clean air passed through the air passage 43 enter inside the second cyclone body 61 through the second air suction port 62, and then forms the second upwardly whirling air current.

The air-discharging pipe 66 is formed in a substantially hollow cylindrical shape, projected upwardly from a center of the bottom end of the second cyclone body 61, and in fluid communication with the vacuum generator 131. A top end and a bottom end of the air-discharging pipe 66 are open, and the top end thereof is lower than the top end of the second cyclone body 61. Therefore, clean air having fine contaminants removed inside the second cyclone body 61 by centrifugal force is discharged to the vacuum generator 131 through the air-discharging pipe 66. Although not shown, an air gathering member may be disposed under the plurality of the air-discharging pipes 66 so that it gathers air discharged from the plurality of air-discharging pipes 66 to the vacuum generator 131.

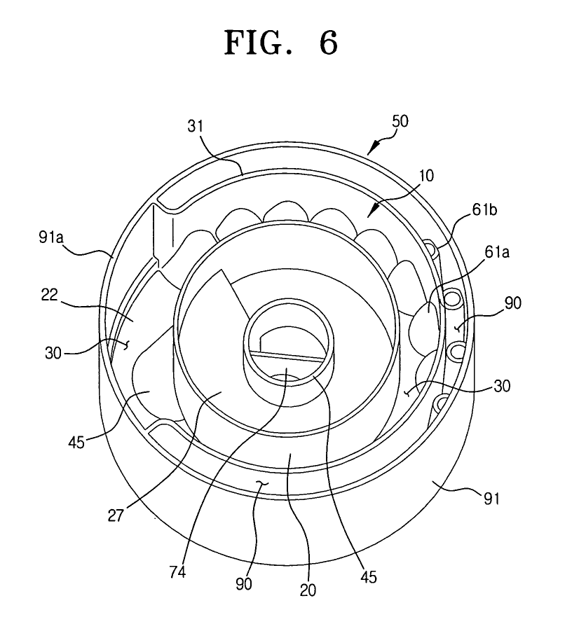

The second dust collecting chamber 90 collects contaminants discharged from the plurality of second cyclones 60, and is formed as a space between the dust collecting wall 31, the dust receptacle 91 and the plurality of second cyclone bodies 61. The dust receptacle 91 is formed in a substantially hollow cylindrical shape wrapping around the outside of the plurality of second cyclones 60. The dust collecting wall 31 is formed to wrap around the inside of the plurality of second cyclones 60. Therefore, opposite ends of the dust collecting wall 31 are connected with the dust receptacle 91, and the part 91a of the dust receptacle 91 not wrapped around the second cyclones 60 forms a sidewall of the first dust collecting chamber 30 as shown in FIG. 6. The plurality of second cyclone bodies 61 blocks a bottom end of the second dust collecting chamber 90. Therefore, contaminants discharged from the plurality of second cyclone bodies 61 are collected in the space between the dust collecting wall 31, the dust receptacle 91, and the plurality of second cyclone bodies 61.

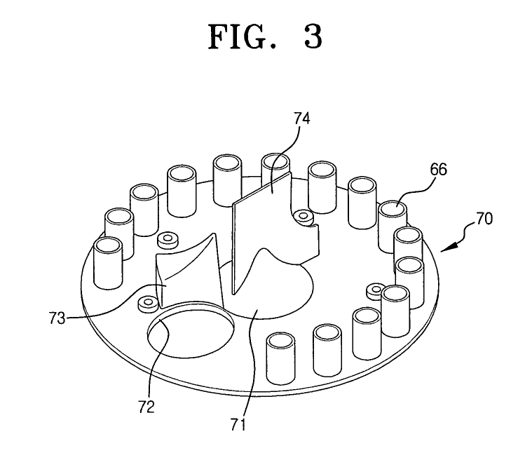

The under cover 70 covers the cyclone bottom member 22 so as to form the plurality of air passages 43 and bottom surfaces of the second cyclone bodies 61. Therefore, preferably the plurality of air-discharging pipes 66 of second cyclones 60 is formed integrally with the under cover 70 as shown in FIG. 3. A structure having the under cover 70 and the plurality of air-discharging pipes 66 formed as one body provides for easy injection molding. Furthermore, the under cover 70 includes an air guide part 71, an air opening 72, and a blocking wall 73. The air guide part 71 is formed in a substantially conical shape on a center of the under cover 70, and guides semi-clean air discharged from the air communicating member 40 to the plurality of air passages 43. It is preferable that an air settling plate 74 is disposed on the air guide part 71 to stabilize airflow inside the air communicating member 40. The air opening 72 is formed in the space where there are no air-discharging pipes 66, and forms an entrance of the air suction pipe 45. The blocking wall 73 is disposed on a side of the air opening 72, and forms some part of the air suction pipe 45 as the under cover 70 is mounted to the cyclone bottom member 22.

Hereinafter, operation and function of the multi-cyclone dust collector 1 according to an embodiment of the present invention will be explained in detail by referring to the accompanying drawings.

A vacuum generator 131 (see FIG. 8) is operated to generate suction force while operating a vacuum cleaner. Air containing contaminants (hereinafter, referred to as dust-laden air) is sucked into a suction brush 110 (see FIG. 8) from a cleaning surface by the suction force. Dust-laden air sucked into the suction brush 110 flows to a multi-cyclone dust collector 1 in fluid communication with the suction brush 110 via a communicating member 121 and 122 (see FIG. 8).

Dust-laden air moved to the multi-cyclone dust collector 1 enters the first cyclone body 20 through the air suction pipe 45 of the first cyclone unit 10. The dust-laden air entering through the air suction pipe 45 forms the first upwardly whirling air current inside the first cyclone body 20. The slope part 27 is disposed in front of the exit 45a of the air suction pipe 45 inside the first cyclone body 20 so that the entering dust-laden air can easily form the first upwardly whirling air current. Then, contaminants are separated from the dust-laden air by centrifugal force of the first upwardly whirling air current. Separated contaminants are discharged to and collected in the first dust collecting chamber 30 through the dust exit 24 between the top end of the first cyclone body 20 and the upper cover 80 as shown by arrow A in FIG. 4. The first dust collecting chamber 30 is isolated from the first upwardly whirling air current by the first cyclone body 20 so that contaminants collected in the first dust collecting chamber 30 do not effect the first upwardly whirling air current inside the first cyclone body 20. Furthermore, air to form the first upwardly whirling air current inside the first cyclone body 20 is directly discharged to the air communicating member 40 so that air collision does not occur inside the first cyclone body 20. Therefore, the dust collecting efficiency of the multi-cyclone dust collector 1 is increased.

Semi-clean air having contaminants removed in the first cyclone body 20 enters the top end of the air communicating member 40 and flows to the bottom end of the air communicating member 40. Semi-clean air passing through the air communicating member 40 collides against the air guide part 71 of the under cover 70 and then is distributed to each of the plurality of air passages 43 wrapping around the air guide part 71. Then, the semi-clean air flows along each of the air passages 43 and enters the second air suction port 62 of each of the plurality of second cyclones 60.

The semi-clean air entering the second air suction port 62 forms the second upwardly whirling air current inside the second cyclone body 61. Fine contaminants are separated from the semi-clean air by centrifugal force of the second upwardly whirling air current. Separated contaminants are discharged to and collected in the second dust collecting chamber 90 over the top end of the second cyclone body 61 as shown by arrow B in FIG. 4. The second dust collecting chamber 90 is isolated by the second cyclone body 61 so that contaminants collected in the second dust collecting chamber 90 do not effect the second upwardly whirling air current inside the second cyclone body 61. Furthermore, air to form the second upwardly whirling air current inside the second cyclone body 61 is directly discharged to the air-discharging pipe 66 so that air collision does not occur inside the second cyclone body 61. Therefore, the dust collecting efficiency of the multi-cyclone dust collector 1 is increased.

Clean air having fine contaminants removed in the second cyclone body 61 is discharged through the air-discharging pipe 66. In all the plurality of second cyclones 60, fine contaminants are removed from semi-clean air by the same operation as described above, and clean air is discharged through the plurality of air-discharging pipes 66. Air discharged to the air-discharging pipes 66 passes through the vacuum generator 131 and then is discharged out of the cleaner body 130.

When the air gathering member (not shown) is disposed under the plurality of air-discharging pipes 66, clean air discharged from each air-discharging pipe 66 of the plurality of second cyclones 60 is gathered together by the air gathering member and then discharged to the vacuum generator 131.

A user can see the quantity of contaminants collected in each of the first and second dust collecting chambers 30 and 90 through the transparent dust receptacle 91 without opening the upper cover 80. When the first and second dust collecting chambers 30 and 90 are filled with contaminants, the first and second dust collecting chambers 30 and 90 require emptying.

When emptying contaminants from the first and second dust collecting chambers 30 and 90, the user first opens the upper cover 80, which covers the top end of the first and second dust collecting chambers 30 and 90. Using the handle 85 of the upper cover 80 makes opening the upper cover 80 easy. Next, by turning the multi-cyclone dust collector 1 downward, contaminants collected in the first and second dust collecting chambers 30 and 90 can be thrown away. A structure allowing the user to see the quantity of contaminants collected in the first and second dust collecting chambers 30 and 90 without opening the upper cover 80 makes the vacuum cleaner more convenient to use, because the user is not required to open the upper cover 80 again and again to confirm the quantity of collected contaminants. Furthermore, a structure in which the upper cover 80 is opened to empty contaminants collected in the first and second dust collecting chambers 30 and 90 allows the user to throw contaminants away while watching the contaminants. Consequently, a structure wherein the upper cover 80 is opened is more convenient to throw contaminants away than a structure wherein the under cover 70 is opened.

Furthermore, because the multi-cyclone dust collector 1 according to an embodiment of the present invention has the upper cover 80 provided with the backflow preventing dam 81, the likelihood is reduced that contaminants collected in the first dust collecting chamber 30 will flow back to the first cyclone body 20 through the dust exit 24 as the multi-cyclone dust collector 1 is inclined.

Hereinafter, as another aspect of the present invention, an example of a vacuum cleaner 100 employing a multi-cyclone dust collector 1 according to the present invention as described above will be explained.

Referring to FIG. 8, a vacuum cleaner 100 according to an embodiment of the present invention includes a suction brush 110, an extension pipe 121, a flexible hose 122, and a cleaner body 130.

The suction brush 110 is provided with a dust suction port in bottom surface thereof to suck dust-laden air from a cleaning surface.

The extension pipe 121 and flexible hose 122 allow the suction brush 110 to be in fluid communication with the cleaner body 130. A grip 120 is disposed on an upper portion of the extension pipe 121. The grip 120 generally has a power switch 123 for turning on the vacuum cleaner 100.

The vacuum generator 131 and the multi-cyclone dust collector 101 are disposed in the cleaner body 130. The vacuum generator 131 generates suction force to suck dust-laden air through the suction brush 110, and is in fluid communication with the multi-cyclone dust collector 101. The multi-cyclone dust collector 101 separates contaminants from dust-laden air sucked from the suction brush 110 and collects the separated contaminants therein. The multi-cyclone dust collector 101 includes a first cyclone unit that takes dust-laden air and forms the first upwardly whirling air current so as to separate and collect relatively large contaminants, and a second cyclone unit that takes air discharged from the first cyclone unit and forms the second upwardly whirling air current so as to separate and collect fine contaminants. The structure and operation of the multi-cyclone dust collector 101 is the same as that of the multi-cyclone dust collector 1 described above, a detailed description thereof is not repeated for conciseness.

Therefore, by turning on the power switch 123 of the vacuum cleaner 100 and then moving the suction brush 110 on a cleaning surface, contaminants on the cleaning surface are sucked into the dust suction port of the suction brush 110 by suction force of the vacuum generator 131. Contaminants sucked into the suction brush 110 flow to the multi-cyclone dust collector 101 through the extension pipe 121 and the flexible hose 122. Contaminants entering the multi-cyclone dust collector 101 are separated and collected by the first and second cyclone units 10 and 50 (see FIG. 4). Clean air having contaminants removed is discharged out of the cleaner body 130.

In above description, a canister type vacuum cleaner is used as an example of vacuum cleaners employing the multi-cyclone dust collector according to an embodiment of the present invention; however, this should not be considered as limiting. Various types of vacuum cleaners such as an upright type vacuum cleaner may employ the multi-cyclone dust collector according to an embodiment of the present invention.

While the embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

What is claimed is:

1. A multi-cyclone dust collector for a vacuum cleaner, comprising:
a first cyclone unit comprising a first cyclone body, and a first dust collecting chamber, the first cyclone body taking dust-laden air entering through an under portion of the first cyclone body and forming a first upwardly whirling air current so as to centrifugally separate contaminants from the dust-laden air, the first dust collecting chamber collecting contaminants discharged from the first cyclone body; and
a second cyclone unit wrapping around at least a portion of the first dust collecting chamber, the second cyclone unit sucking semi-clean air discharged from the first cyclone unit through an under portion of the second cyclone unit, the second cyclone unit taking the semi-clean air and forming a second upwardly whirling air current so as to centrifugally separate fine contaminants from the semi-clean air.

2. The multi-cyclone dust collector of claim 1, wherein the first cyclone unit comprises:
an air communicating member disposed inside the first cyclone body, the air communicating member discharging the semi-clean air to the second cyclone unit;
a dust collecting wall wrapping around the first cyclone body so as to form the first dust collecting chamber; and
an air suction pipe is disposed at a bottom of the first cyclone body, the air suction pipe forming the dust-laden air into the first upwardly whirling air current.

3. The multi-cyclone dust collector of claim 2, wherein the air communicating member is formed in a substantially cylindrical shape, the air communicating member having an open top end and a bottom end, the bottom end being formed as a plurality of air passages in fluid communication with the second cyclone unit.

4. The multi-cyclone dust collector of claim 3, further comprising an air guide member formed at a center of a bottom end of the air communicating member.

5. The multi-cyclone dust collector of claim 2, wherein the second cyclone unit comprises:
a plurality of second cyclones wrapping around the dust collecting wall, under portions of the plurality of second cyclones in fluid communication with the bottom end of the air communicating member, the plurality of second cyclones taking the semi-clean air entering through the air communicating member and forming the second upwardly whirling air current so as to separate fine contaminants from the semi-clean air; and
a second dust collecting chamber wrapping around the plurality of second cyclones, the second dust collecting chamber collecting fine contaminants discharged from the plurality of second cyclones.

6. The multi-cyclone dust collector of claim 5, wherein each of the plurality of second cyclones comprises:
a second cyclone body formed in a substantially hollow conical shape with a closed bottom end, the second cyclone body having a second air suction port in fluid communication with the second cyclone body and with the bottom end of the air communicating member; and
an air-discharging pipe formed in a substantially hollow cylindrical shape, the air-discharging pipe projected upwardly from a center of the bottom of the second cyclone body, and discharging clean air.

7. The multi-cyclone dust collector of claim 5, further comprising an upper cover detachably connected to upper ends of the first and second cyclone units.

8. The multi-cyclone dust collector of claim 7, wherein the upper cover comprises a backflow preventing dam to prevent contaminants collected in the first dust collecting chamber from flowing back to the first cyclone body.

9. The multi-cyclone dust collector of claim 8, wherein the upper cover further comprises a substantially dome-shaped contaminants guide member on a center of a bottom surface of the upper cover.

10. The multi-cyclone dust collector of claim 5, wherein each of the plurality of second cyclones comprises a cyclone body, a top end of the cyclone body being inclined in an opposite direction of the first cyclone unit with respect to a bottom end of the cyclone body.

11. The multi-cyclone dust collector of claim 10, wherein at least one of the plurality of second cyclones extends into the first dust collecting chamber.

12. The multi-cyclone dust collector of claim 5, wherein the second dust collecting chamber is formed as a space between a dust receptacle and a dust collecting wall, the dust receptacle having a substantially hollow cylindrical shape and wrapping around the plurality of second cyclones and the first cyclone body, the dust collecting wall having opposite ends thereof connected with the dust receptacle;
wherein the first dust collecting chamber is formed as a space between the first cyclone body, the dust collecting wall, and a portion of the dust receptacle not wrapped around the plurality of second cyclones;
wherein contaminants collected in the first and second dust collecting chambers can be seen from outside the dust receptacle.

13. The multi-cyclone dust collector of claim 1, wherein the first cyclone unit comprises a plurality of cyclones.

14. A multi-cyclone dust collector for a vacuum cleaner comprising:
a first cyclone unit comprising at least one first cyclone body that separates contaminants from dust-laden air; and
a second cyclone unit separating fine contaminants from semi-clean air discharged from the first cyclone unit, the second cyclone unit comprising a plurality of second cyclones that is separate from the first cyclone body and wraps around at least a portion of the first cyclone body;
wherein the first and second cyclone units have bottom portions on the same horizontal surface.

15. The multi-cyclone dust collector of claim 14, wherein the plurality of second cyclones suck the semi-clean air through an under portion of a side of the plurality of second cyclones, and then discharge air to an under portion of a center of the plurality of second cyclones.

16. The multi-cyclone dust collector of claim 14, wherein the contaminants collected in the first cyclone unit can be seen through a portion of the first cyclone unit that is not wrapped around by the plurality of second cyclones.

17. A dust collecting method comprising steps of:
entering dust-laden air into a bottom portion of at least one first cyclone;
whirling the dust-laden air upwardly to separate contaminants from the dust-laden air to form semi-clean air;
discharging the contaminants out of the at least one first cyclone;
discharging semi-clean air to the bottom portion of the at least one first cyclone through an air communicating member disposed inside the at least one first cyclone;
entering the semi-clean air into a plurality of second cyclones through second air suction ports formed on bottom portions of sides of the plurality of second cyclones, whirling the semi-clean air upwardly to separate fine contaminants from the semi-clean air to form clean air; and
discharging the clean air to the bottom portions of the plurality of second cyclones.

18. The dust collecting method of claim 17, wherein the step of whirling the dust-laden air upwardly comprises discharging the contaminants through an open top end of the first cyclone body and collecting the contaminants in a first dust collecting chamber formed around the first cyclone body.

19. The dust collecting method of claim 17, wherein the step of entering the semi-clean air into a plurality of second cyclones comprises discharging the fine contaminants over top ends of the plurality of second cyclones, and collecting the fine contaminants in a space between the plurality of second cyclones.
